(19) United States
(12) Patent Application Publication
(10) Pub. No.: US 2021/0125105 A1
(43) Pub. Date: Apr. 29, 2021

(54) System and Method for Interest-focused Collaborative Machine Learning

(71) Applicant: THE UNITED STATES OF AMERICA, AS REPRESENTED BY THE SECRETARY OF THE NAVY, Arlington, VA (US)

(72) Inventors: Geoffrey G. XIE, Monterey, CA (US); Brandon R. HEE, Pinole, CA (US)

(21) Appl. No.: 17/076,564

(22) Filed: Oct. 21, 2020

Related U.S. Application Data
(60) Provisional application No. 62/924,984, filed on Oct. 23, 2019.

(51) Int. Cl. G06N 20/00; G06K 9/62; G06N 5/02; G06F 16/907

(52) U.S. Cl. CPC G06N 20/00; G06F 16/907; G06N 5/022; G06K 9/6256

(57) ABSTRACT

A system and method for interest-focused collaborative machine learning which uses a machine learning model to advance a common interest while pooling both computing resources and data from a group of participant users.

### CROSS-REFERENCE TO RELATED APPLICATIONS

This patent application is a non-provisional of and claims the benefit of U.S. Provisional application 62/924,984, filed Oct. 23, 2019, which is hereby incorporated by reference in its entirety.

### BACKGROUND OF THE INVENTION

### 1. Field of the Invention

One or more embodiments relate to an interest-focused collaborative machine learning model to advance a common interest while pooling both computing resources and data from a group of participant users.

### 2. Description of the Related Art

The current proliferation of smartphones and other mobile devices allows users to collect large amounts of data in various genres, frequently in real time. The focused collection and processing of that data and more importantly, the dissemination of up to date knowledge that can be learned from the data to others sharing similar interests in a timely manner is often difficult due to the vast array of communication networks and hosting systems and the geographically dispersed user base.

### SUMMARY OF THE INVENTION

Embodiments in accordance with the invention include a system and a method for interest-focused collaborative machine learning which use a machine learning model to advance a common interest while pooling both computing resources and data from a group of participant users. The interest can be personal, in which case participation is voluntary, or organizational, in which case participation may be mandated for selected members of an organization. Each participant user downloads a participant application including a machine learning model to a participant device. The participant application includes a first sub-application which mines, e.g., collects, local data items on the participant device and displays pertinent local data items to the participant user via a graphical user interface (GUI) displayed on the participant device. The participant user can opt-in sharing all presented data items or manually selected data items. The participant application further includes a second sub-application which uses the local data items selected to perform incremental data updates to the machine learning model downloaded and stored on the participant device. In some embodiments, a surrogate computing device designated by the participant user is used to install the machine learning model and perform incremental data updates. The participant device(s) send the incremental data updates to a computer server, such as cloud server, that periodically aggregates the received incremental data updates, updates the machine learning model stored on the computer server, and distributes the latest updated machine learning model to participant device(s) to benefit all participant users.

Embodiments in accordance with the invention are best understood by reference to the following detailed description when read in conjunction with the accompanying drawings.

### BRIEF DESCRIPTION OF THE DRAWINGS

FIG. 1 illustrates a schematic diagram of a system and method for interest-focused collaborative machine learning in accordance with one embodiment of the invention.

FIG. 2 illustrates a method for the updated knowledge operation of FIG. 1 in accordance with one embodiment of the invention.

FIG. 3 illustrates a method for the send knowledge operation of FIG. 1 in accordance with one embodiment of the invention.

FIG. 4 illustrates a method for the mine local data operation of FIG. 1 in accordance with one embodiment of the invention.

FIG. 5 illustrates a method for the participant confirms data selection operation of FIG. 1 in accordance with one embodiment of the invention.

FIG. 6 illustrates a method for the participant labels data operation of FIG. 1 in accordance with one embodiment of the invention.

FIG. 7 illustrates a method for the train IFML model operation of FIG. 1 in accordance with one embodiment of the invention.

FIG. 8 illustrates a method for the surrogate device computation operation of FIG. 7 in accordance with one embodiment of the invention.

Embodiments in accordance with the invention are further described herein with reference to the drawings.

### DETAILED DESCRIPTION OF THE INVENTION

Embodiments in accordance with the invention utilize a machine learning model to advance a common interest while pooling both computing resources and data from a group of participant devices. Each participant user, herein also referred to as a user, downloads a participant device application in conjunction with the machine learning model. In one embodiment the participant device application can be embodied as a first sub-application and a second sub-application. The first sub-application mines local data on each participant device and presents pertinent data items to a user using a GUI so that a voluntary user can opt-in sharing all items identified or manually select data items to share. The second sub-application uses local data shared by the user of a participant device to perform incremental model updates on each participant device of a group of participant devices, or on a surrogate computing device designated by the user. Participant devices send the incremental updates to a server that periodically aggregates the received incremental updates and distributes the latest machine learning model to benefit all users of participant devices.

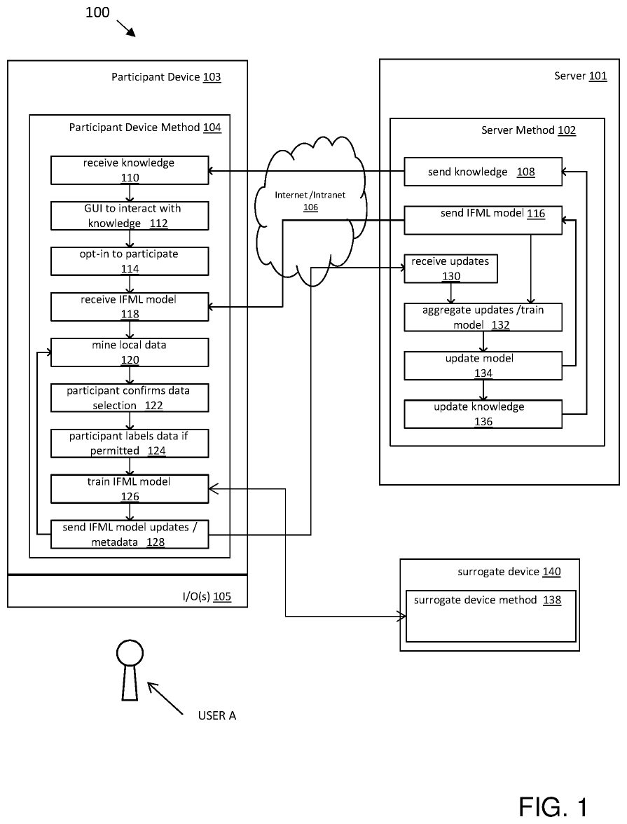

FIG. 1 illustrates a schematic diagram of a system 100 and method, shown as implemented in operations 108 through 136, and in some embodiments, optionally through 138, for interest-focused collaborative machine learning in accordance with one embodiment of the invention. In the present embodiment, the method for interest-focused collaborative machine learning is shown in FIG. 1 as operations implemented on a computer-based server 101 and one or more computer based participant devices 103, such as a computer laptop device, a smartphone, or other computer-based device. In one embodiment, the operations of a server method 102 implemented on server 101 are embodied as a computer-implemented application stored in a memory of server 101, and the operations of a participant device method 104 implemented on participant device 103 are embodied as a computer-implemented application stored in a memory of participant device 103. Participant device(s) 103 and server 101 are communicatively coupled via a network 106, such as via the Internet or an intranet.

In some embodiments, participant device(s) 103 may also be communicatively coupled to a surrogate device 140. Surrogate device 140 can be a mobile device, personal computer, or other computing resource, communicatively coupled to participant device(s) 103, such as through direct connection, via network 106, or via another Internet or intranet connection (not shown). In one embodiment, the operations of a surrogate device method 138 implemented on surrogate device 140 are embodied as a computer-implemented application stored in a memory of surrogate device 140. In one embodiment, surrogate device 140 is preconfigured to synchronize with participant device 103.

As is well known to those of skill in the art each of server 101, participant device 103, and surrogate device 140 typically include an operating system, one or more memories for storing the operations of the method, one or more various input/output devices 105, such as a display screen and keyboard, and communications modems.

At operation 108, an initial knowledge representation derived from an interest-focused machine learning model stored on server 101 is sent from a server 101 to participant device 103 through network 106. At operation 110, participant device 103 receives the knowledge representation. At operation 112, a graphical user interface (GUI) is displayed on participant device 103 to a user A with which user A can interact with the received knowledge representation. At operation 114, user A can choose to opt-in via an input to the GUI and share data collected on participant device 103 to improve the interest-focused machine learning model, sending a notification to server 101 to proceed to operation 116. In some cases, an organization may require its participant devices 103 to opt-in and share data. When server 101 receives notification that participant device 103 has opted-in, in operation 116, server 101 sends an interest-focused machine learning model stored on server 101 to participant device 103 through network 106. At operation 118, participant device 103 receives the interest-focused machine learning model and initiates operation 120 in which an automated process stored on participant device 103 mines local data stored on participant device 103.

In operation 122, the local data mined in operation 120 is displayed via a GUI on participant device 103, and user A is required to confirm what local data can be used to train the interest-focused machine learning model via one or more inputs to the GUI. In one embodiment, in operation 124, user A may label the local data via the GUI to assist with training the interest-focused machine learning model. In operation 126, the selected data is used to train the interest-focused machine learning model. In some embodiments, training the interest-focused machine learning model is not limited to the computational capability of participant device 103. In some embodiments, user A of participant device 103 may choose to offload the computation to a server, such as server 101, or to another computer-based device accessible by user A, such as surrogate device 140.

In operation 128, the interest-focused machine learning model is updated with the local data and any required metadata from the local data is sent to server 101. In operation 130, server 101 receives the model updates from participant device 103 and any other participant devices 103 (not shown). At operation 132, server 101 aggregates the model updates and trains the interest-focused machine learning model stored on server 101 using the accumulated model updates received in operation 130. In operation 134, the updated interest-focused machine learning model is used to generate an updated knowledge representation output in operation 136. The updated knowledge representation is then used in operation 108 for distribution to participant device(s) 103, giving user A and other users of the participant device(s) 103 access to the benefits of the updated knowledge representation.

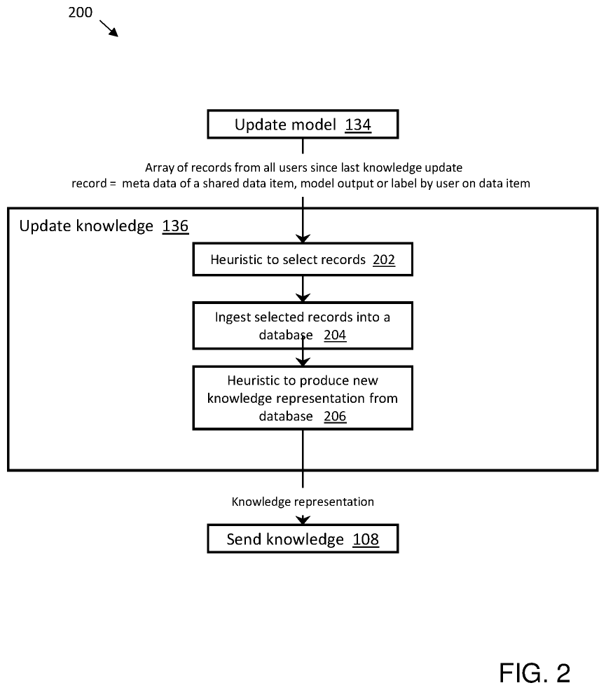

FIG. 2 illustrates a method 200 for update knowledge operation 136 in accordance with one embodiment of the invention. Referring now to FIGS. 1 and 2, a digital knowledge representation, e.g., digital images or a database that can be queried, that advances the interest of individual participant users or an organization is stored on server 101. In one embodiment, method 200 updates the knowledge representation periodically, for example, daily, using all data records received from all participant device(s) 103 since server 101 implemented a last knowledge update. Each input data record to operation 136 includes the meta-data, for example, the time and place of acquisition, of a data item shared by a participant device 103 and the final label or action determined or confirmed for that data item. In operation 202, a deployment specific heuristic is used to rank the suitability of the input data records and select a subset of them for the current iteration of knowledge update. In operation 204, the selected data items are formatted and added to a deployment specific database designed to store the raw data required to produce updates to the knowledge representation. In operation 206, the deployment specific heuristic is used to update the knowledge representation from the raw database at a pre-designated time. The updated knowledge representation from the database is sent to operation 108 in which a notification is sent to participant device(s) 103 of a new update and the updated knowledge representation is made available to participant users, such as user A.

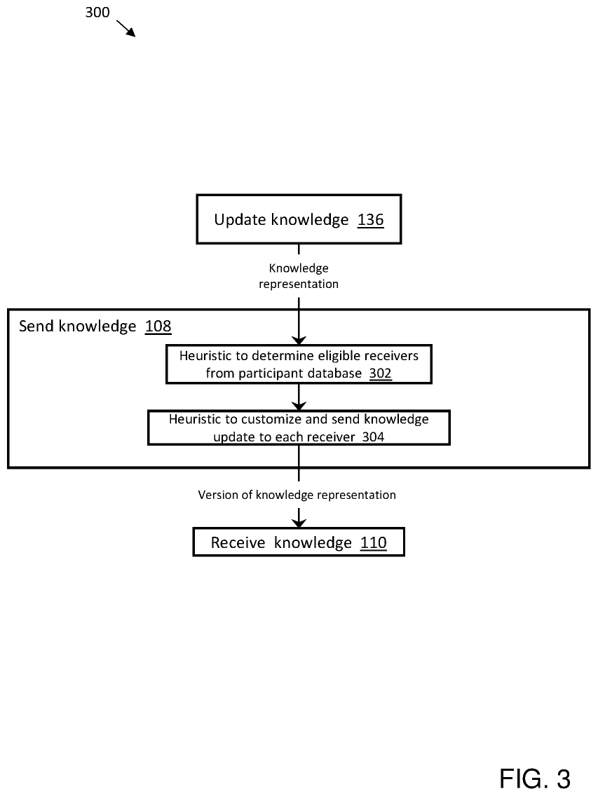

FIG. 3 illustrates a method 300 for send knowledge operation 108 of FIG. 1 in accordance with one embodiment of the invention. Referring now to FIGS. 1 through 3, once operation 136 completes the knowledge update process, the updated knowledge representation is disseminated to participant device(s) 103. In one embodiment, method 300 is a server-push model of dissemination, in which server 101 distributes a version of the updated knowledge representation to each eligible participant device 103. In other embodiments, a participant-pull model can be used, in which participant device 103 will automatically check for and download a new knowledge representation at a pre-configured time of day, or user A can manually select a menu operation on a GUI to check for and download a new knowledge representation.

In operation 302, a deployment-specific heuristic is used to identify eligible participant receivers of a knowledge update based on the participant's level of contribution to the model operation, for example, based on a subscription payment, data and computing resources, etc. In operation 304, another heuristic is used to determine a version of an update for each eligible participant device 103 and then sends the knowledge update to the eligible participant device 103, for example, by utilizing a TCP/IP connection.

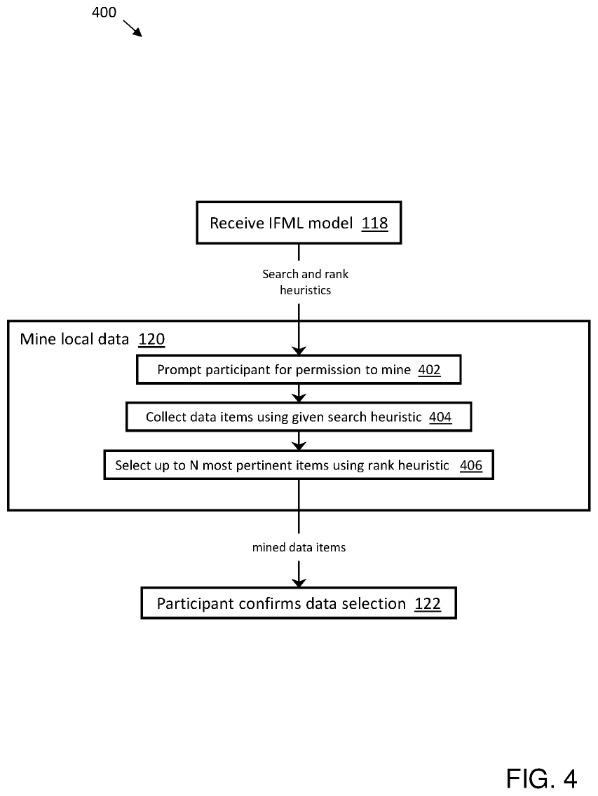

FIG. 4 illustrates a method 400 for mine local data operation 120 of FIG. 1 in accordance with one embodiment of the invention. Referring now to FIGS. 1 through 4, once participant device 103 successfully receives the machine learning model sent in operation 116, operation 120 proceeds to mine local data stored in a memory on participant device 103. In operation 402, a GUI is displayed on participant device 103 prompting user A for input of consent to mine specific data type(s) stored on participant device 103. When user A inputs consent, processing continues to operation 404. In operation 404, a deployment-specific heuristic is utilized to search through the memory storage of participant device 103 and collect a set of data items as potential input for model training. In operation 406, another heuristic is utilized to examine and rank the collected data items before forwarding the top N items, where N is a deployment specific parameter, to operation 122.

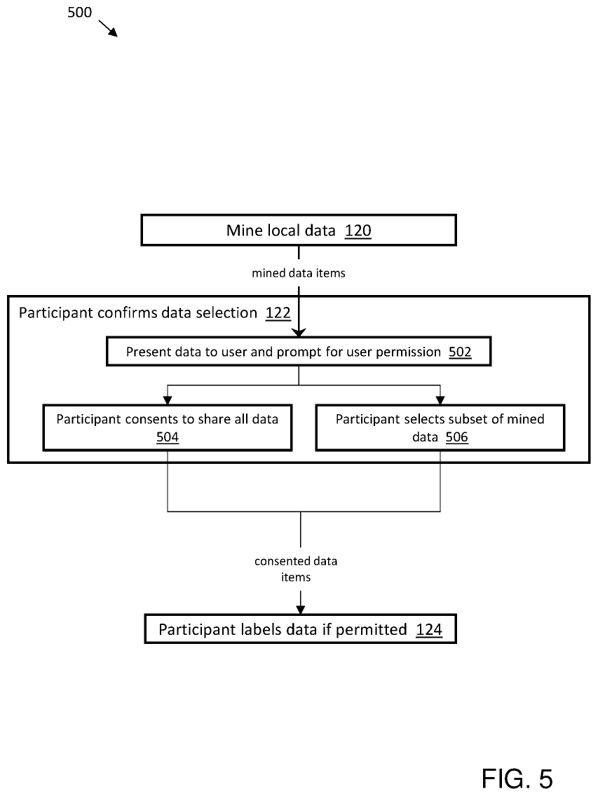

FIG. 5 illustrates a method 500 for participant confirms data selection operation 122 of FIG. 1 in accordance with one embodiment of the invention. Referring now to FIGS. 1 through 5, once local data has been mined from participant device 103, a user A confirms data selection. In operation 502, the mined data items are presented on a GUI to a user A, and user A is prompted for consent to use the mined data items. In the present embodiment, the mined data items are displayed on a GUI on participant device 103. The mined data can be displayed in various formats and data item types. In operation 504, when user A inputs consent to share the mined data, in one embodiment, the full set of mined data items collected in operation 120 are input to operation 124. Alternatively, in operation 506, user A can select a subset of the mined data items displayed on the GUI for input to operation 124. For example, user A can select or deselect individual data items via the GUI for input to operation 124. In some embodiments, participant device 103 can store a user's selection of operation 504 or operation 506 for use as default selection for future iterations of operation 122.

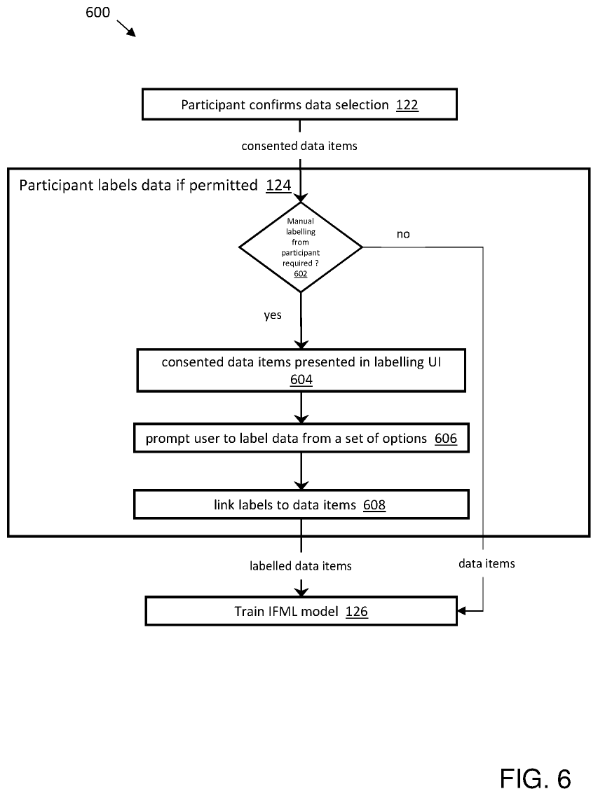

FIG. 6 illustrates a method 600 for participant labels data operation 124 of FIG. 1 in accordance with one embodiment of the invention. Referring now to FIGS. 1 through 6, in decision operation 602, a determination whether user manual labelling is required by the IFML's metadata or transmitted from server 101 to participant device 103 as a separate parameter is determined. When the consented mined data items do not require user labelling (“no”), the consented mined data items are input to operation 126. Alternatively, when the consented mined data items do require user labelling (“yes”), in operation 604, the consented mined data items are presented to the participant, e.g., user A, in a GUI displayed on participant device 103. In one embodiment, in operation 606, the GUI displays a prompt to the participant to label data from a set of displayed options. In operation 608, the participant labels the data items from a set of displayed options. In some embodiments, the participant, e.g., user A, is permitted to input labels outside the set of displayed options. In operation 610, the selected/input labels are linked to the data items before being input to operation 126. The linking can be through a custom data structure, or can be through use of a separate list or database which correlates labels to data items.

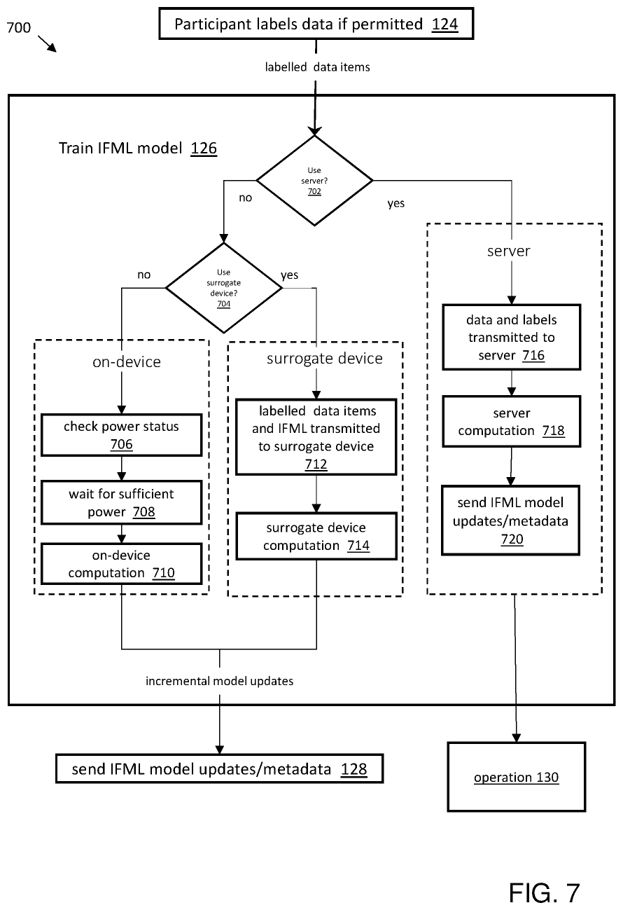

FIG. 7 illustrates a method 700 for train IFML model operation 126 of FIG. 1 in accordance with one embodiment of the invention. Referring now to FIGS. 1 through 7, operation 126 determines which computing device will be used to train the IFML model with the consented data items. In decision operation 702, a determination is made whether a participant has consented to utilize server 101 to train the IFML model with the consented data items. For example, a GUI may display a consent query to user A on participant device 103 in which user A selects whether to use server 101, e.g., inputs a consent/no consent selection. When a consent is input (‘yes’), in operation 716, the consented data items and associated labels, if required, are transmitted to server 101. In operation 718, server 101 computes the incremental model updates and in operation 720 sends the IFML model updates/metadata as inputs to operation 130.

Referring again to decision operation 702, alternatively, if user A does not want to transmit data items to server 101 {‘no’), at decision operation 704, user A can select whether to compute the incremental model update using participant device 103 or use surrogate device 140 for computation. As earlier described, surrogate device 140 can be a mobile device, personal computer, or other computing resource, communicatively coupled to participant device 103. In one embodiment, surrogate device 140 is preconfigured to synchronize with participant device 103. In one embodiment, surrogate device 140 includes a surrogate device method 138 stored on surrogate device 140 to compute the incremental model updates to train the IFML model.

In decision operation 704, a determination is made whether user A has selected to utilize surrogate device 140 to train the IFML model with the consented data items. For example, a GUI may display a selection query to user A on participant device 103 in which user A selects whether to use surrogate device 140 to train the IFML model. When a selection of surrogate device 140 is input (“yes”), in operation 712, the data items, associated labels, and IFML will be transmitted to surrogate device 140. In operation 714, surrogate device 140 computes the incremental updates and communicates the incremental updates to participant device 103 where the incremental updates are input to operation 128 of participant device method 104 and then transmitted to server 101 and input to operation 130 of server method 102.

Alternatively, in decision operation 704, when surrogate device 140 is not selected (“no”), participant device 103 is used to train the IFML model. In one embodiment, in operation 706, the power status of participant device 103 is checked to ensure there is reliable power for training the IFML model. This is a particular concern for battery powered devices. In operation 708, the power status and approximate power consumption of participant device 103, as determined by the operating system, can be used to determine if the IFML model training occurs immediately or is idled until there is sufficient power. In operation 710, when adequate power is available, participant device 103 computes the incremental model updates and inputs them to operation 128 in which the incremental model updates are transmitted to server 101 and input to operation 130 of server method 102.

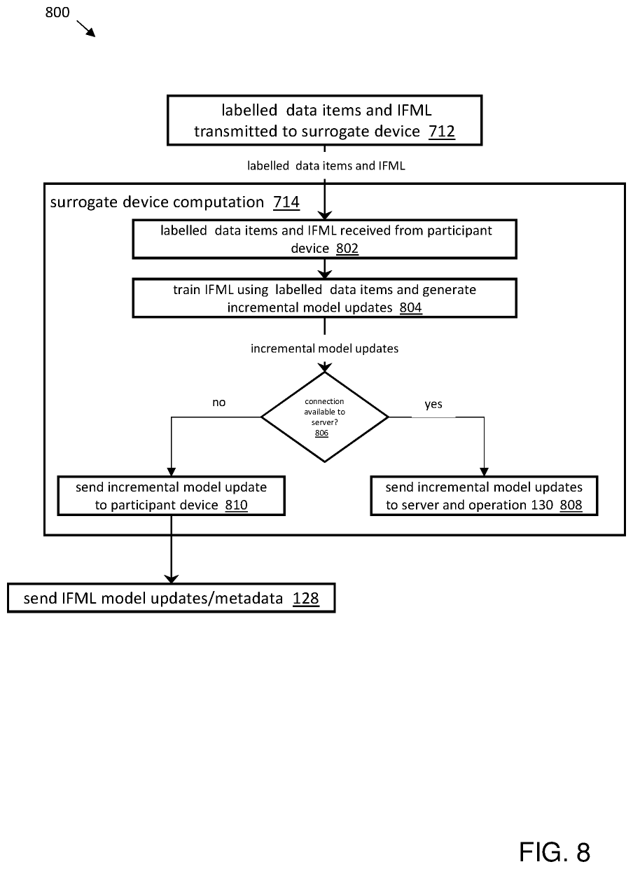

FIG. 8 illustrates a method 800 for surrogate device computation operation 714 of FIG. 7 in accordance with one embodiment of the invention. Referring now to FIGS. 1 through 8, in operation 802, surrogate device 140 receives the labelled the data items, associated labels, and IFML. In operation 804, the surrogate device trains the IFML using the data items and generates an incremental model update. In decision operation 806, a determination is made whether a connection to server 101 is available. When a connection to server 101 is available (“yes”), in operation 810, surrogate device 140 sends the incremental model update to server 101 via a network, such as network 106, for use at operation 130. Alternatively, at decision operation 806, when a connection to server 101 is not available (“no”), in operation 810, surrogate device 140 sends the incremental model update to participant device 103. Participant device 103 is then responsible at operation 128 for transmitting the incremental model update to server 101 and operation 130.

This description provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

It is to be understood that the above-described arrangements are only illustrative of the application of the principles of the present invention and it is not intended to be exhaustive or limit the invention to the precise form disclosed. Numerous modifications and alternative arrangements may be devised by those skilled in the art in light of the above teachings without departing from the spirit and scope of the present invention.

What is claimed is:

1. A system for interest-focused collaborative machine learning comprising:
a first computer device including a first computer device-based application for interest-focused collaborative machine learning (IFML), the first computer device communicatively coupled to a network;
a network, the network communicatively coupled to the first computer device and one or more second computer devices; and,
one or more second computer devices, the second computer devices each including a second computer device-based application for IFML,
wherein an initial IFML model is transmitted form the first computer device to one or more second computer devices over the network, each of the one or more second computer devices generates an IMFL incremental model update using local data items collected from the second computer device and sends the IMFL incremental model update to the first computer device, and wherein the first computer device receives one or more IMFL incremental model updates, updates an IFML model stored on the first computer device based on the one or more IMFL incremental model updates, and generates an updated IFML model for distribution to the one or more second computer devices.

2. The system of claim 1 further comprising:
a third computer device communicatively coupled to a second computer device,
wherein the second computer device utilizes the third computer device to generate the incremental model update, the third computer device generating the incremental update and sending the incremental model update to the second computer device for sending to the first computer device.

3. The system of claim 1 further comprising:
wherein the second computer device utilizes the first computer device to generate the IMFL incremental model update, the first computer device generating the IMFL incremental model update.

4. The system of claim 1 wherein:
the first computer device is a server computer and includes a server method for IMFL; and,
each of the one or more second computer devices is a participant computer device, each participant computer device including a participant device method for IMFL.

5. The system of claim 1 where in the second computer device-based application for IFML permits a user to select one or more of the local data items collected from the second computer device.

6. A method for interest-focused collaborative machine learning (IFML) comprising:
sending a knowledge representation generated by a machine learning model from a server device to one or more participant devices over a network;
receiving the knowledge representation at the one or more participant devices;
sending a trainable interest-focused machine learning (IFML) model from the server device to the one or more participant devices over the network;
receiving the trainable IFML model at each of the one or more participant devices;
at each of the one or more participant devices:
collecting local data items from a storage memory on a participant device;
selecting one or more of the local data items for use in training the trainable IFML model;
training the trainable IFML model utilizing the selected one or more local data items;
generating an IFML incremental model update; and,
sending the IFML incremental model update from the participant device to the server device over the network;
receiving the IFML incremental model updates at the server device;
training a server device-based IFML model based on at least one of the IFML incremental model updates received from the participant devices;
generating an updated server device-based IFML model; and,
updating the knowledge representation based on the updated server device-based IFML model to generate an updated knowledge representation.

7. The method of claim 6 further comprising:
sending the updated knowledge representation from the server device to a participant device over the network.

8. The method of claim 6 further comprising:
aggregating the IFML incremental model updates and training the server device-based IFML model based on the IFML incremental model updates received from the participant devices.

9. The method of claim 6 wherein training the trainable IFML model utilizing the selected one or more local data items comprises:
checking the power status of the participant device;
waiting for sufficient power on the participant device to calculate an IFML incremental model update; and,
calculating the IFML incremental model update on the participant device.

10. The method of claim 6 wherein training the trainable IFML model utilizing the selected one or more local data items comprises:
transmitting the IFML model and the selected one or more local data items to a surrogate device;
calculating the IFML incremental model update on the surrogate device; and,
sending the IFML incremental model update to the participant device.

11. The method of claim 6 wherein training the trainable IFML model utilizing the selected one or more local data items comprises:
transmitting the IFML model and the selected one or more local data items to the server device;
calculating the IFML incremental model update on the server device; and,
inputting the IFML incremental model update to train the server device-based IFML model.

12. The method of claim 6 wherein collecting local data items from a storage memory on a participant device includes metadata.
